(19) United States
(12) Patent Application Publication
(10) Pub. No.: US 2017/0105040 A1
(43) Pub. Date: Apr. 13, 2017

(54) DISPLAY METHOD, APPARATUS AND RELATED DISPLAY PANEL

(71) Applicant: BOE TECHNOLOGY GROUP CO., LTD, Beijing (CN)

(72) Inventors: JIAN GAO, Beijing (CN); HAO WANG, Beijing (CN)

(21) Appl. No.: 15/033,809

(22) PCT Filed: Sep. 18, 2015
(86) PCT No.: PCT/CN2015/089990

§ 371 Date: May 2, 2016

(30) Foreign Application Priority Data
Mar. 25, 2015 (CN) 201510132266.6

(51) Int. Cl. H04N 21/431; H04N 21/81; H04N 21/478; H04N 21/482; H04N 21/4722; H04N 21/44

(52) U.S. Cl. CPC H04N 21/4316; H04N 21/4722; H04N 21/44008; H04N 21/478; H04N 21/4828; H04N 21/8126; H04N 21/4821; G06F 3/0486

(57) ABSTRACT

The present invention provides a display apparatus having a display screen. The display apparatus includes a display control module; a program receiving module configured to receive the currently played TV program, and send the currently played TV program to the display control module; and a matching module configured to search for information related to the currently played TV program, associate the searched information with the currently played TV program, and send the searched information to the display control module. Further, the display control module may divide a whole display area of a display screen into a first display area and a second display area, control the display screen to show the currently played TV program in the first display area, and control the display screen to dynamically present the searched information associated with the currently played TV program in the second display area.

### CROSS-REFERENCES TO RELATED APPLICATIONS

This application claims the priority of Chinese Patent Application No. 201510132266.6, entitled “Television Display Method and Apparatus,” filed on Mar. 25, 2015, the entire content of which is incorporated herein by reference.

### FIELD OF THE DISCLOSURE

The present disclosure relates to the field of display technologies and, more particularly, relates to a display method and a display apparatus.

### BACKGROUND

Nowadays, display products such as TVs are becoming digitized and smart, so that users have more choices to access information. For example, a TV may be connected to the Internet through network carriers, allowing users to watch news, play videos, etc. In the era of big data, when facing massive volume of information, how to obtain the most useful information in the shortest amount of time has become a pressing need.

For example, when watching an episode of a TV series, a user may show great interest on a product in a certain scene of the episode, such as a bottle of wine, a stylish outfit, or a new brand of kitchenware. The user may want to know relevant information of the product immediately, such as where the product can be purchased and how much the product costs. Under this circumstance, the user may pause watching the episode and turn to a computer to conduct a search. Alternatively, the user may write down the name of the product right away, and search for the relevant information after the episode is finished.

In another example, when watching news, usually a TV can only broadcast news from one TV channel. When a user want to browse news in the same subject but from different areas or local news, the user have to switch between TV channels, or turn on the computer and conduct related news search, or buy local journals and newspapers to look for related news information. Current display technologies and display devices may not simultaneously display contents and perform other operations such as searching and shopping, and thus deliver poor user experience and cannot satisfy users' needs.

Therefore, it is necessary to provide a display apparatus that can show TV programs and relevant contents from the Internet in a same scene mode, and thus enhancing the user experience.

The disclosed method and system are directed to solve one or more problems set forth above and other problems.

### BRIEF SUMMARY OF THE DISCLOSURE

One aspect of the present disclosure provides a display apparatus having a display screen. The display apparatus may include a display control module, a program receiving module and a matching module. The display control module may be configured to control a presentation of a currently played TV program. The program receiving module may be configured to receive the currently played TV program, and send the currently played TV program to the display control module. The matching module may be configured to search for information related to the currently played TV program, associate the searched information with the currently played TV program, and send the searched information to the display control module. Further, the display control module is configured to divide a whole display area of a display screen into a first display area and a second display area, control the display screen to show the currently played TV program in the first display area, and control the display screen to dynamically present the searched information associated with the currently played TV program in the second display area.

The display control module may be further configured to: control the display screen to divide the display screen into the first display area and the second display area when the display control module receives a command to turn on a smart display mode; and control the display screen to show the currently played TV program in the whole display area when the display control module receives a command to turn on a normal display mode.

The display control module may be further configured to divide the whole display area into the first display area and the second display area based on fixed ratios, wherein the first display area is larger than the second display area; or divide the whole display area into the first display area and the second display area based on an aspect ratio of the currently played TV program, wherein an aspect ratio of the first display area equals the aspect ratio of the currently played TV program.

The display control module may be configured to adjust a picture size of the currently played TV program according to a size of the first display area; and display the adjusted currently played TV program in the first display area.

Further, the program receiving module may be configured to receive an electronic program guide together with the currently played TV program, and send the electronic program guide to the matching module; and the matching module may be configured to search for information related to the currently played TV program according to the received electronic program guide.

The display control module is further configured to receive an image selected by a user from the first display area, and send a matching request containing the selected image to the matching module; the matching module is further configured to search online for results related to the selected image based on the matching request, associate the search results with the currently played TV program, and send the search results to the display control module; and the display control module is further configured to present the search results corresponded to the currently played TV program in the second display area.

The display control module is further configured to receive an item selected by a user among the searched information presented in the second display area and send a search request containing the selected item to the matching module; the matching module is further configured to search online for a shopping link of the selected item based on the search request, generate order information according to the shopping link, and send the order information to the display control module; and the display control module is further configured to present the order information in the second display area to facilitate the user to complete the order according to the order information.

The display screen may be a touch screen. When the user touches the display screen to select an image in the first display area, and drag the selected image to the second display area, the display control module is further configured to generate the matching request containing the selected image.

Another aspect of the present disclosure provides a display method that can be implemented on a display screen. The method includes receiving a currently played TV program and searching information related to the currently played TV program. The method further includes associating the searched information with the currently played TV program, and dividing a whole display area of the display screen into a first display area and a second display area. The method further includes displaying the currently played TV program in the first display area and displaying the searched information in the second display area.

When the display apparatus receives a command to turn on a smart display mode, the method further includes dividing the whole display area of the display screen into the first display area and the second display area. When the display apparatus receives a command to turn on a normal display mode, the method further includes displaying the currently played TV program in the whole display area of the display screen.

Further, dividing the whole display area of the display screen into the first display area and the second display area includes one of: dividing the whole display area into the first display area and the second display area based on fixed ratios, the first display area being larger than the second display area; or dividing the whole display area into the first display area and the second display area based on an aspect ratio of the currently played TV program so that an aspect ratio of the first display area being equal to the aspect ratio of the currently played TV program.

The display method may further include adjusting a picture size of the currently played TV program according to a size of the first display area; and displaying the adjusted currently played TV program in the first display area.

The display method may further include receiving the currently played TV program further comprises receiving an electronic program guide corresponding to the currently played TV program; and searching information related to the currently played TV program further comprises searching information related to the currently played TV program according to the received electronic program guide.

The display method may further include generating a matching request containing a selected image when receiving the image selected by a user from the first display area; searching online for results related to the selected image based on the matching request; associating the search results with the currently played TV program; and presenting the search results associated with the currently played TV program in the second display area.

The display method may further include receiving an item selected by a user among the searched information presented in the second display area; generating a search request containing the selected item; searching online for a shopping link of the selected item; generating order information according to the shopping link; and presenting the order information in the second display area to facilitate the user to complete the order according to the order information.

Further, the display screen may be a touch screen. The method may further include generating the matching request containing the selected image when the user touches the display screen to select an image in the first display area, and drag the selected image to the second display area.

Another aspect of the present disclosure provides a smart display panel incorporating one or more display apparatus described above.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary environment incorporating various embodiments of the present disclosure;

FIG. 2 illustrates an exemplary computing system according to various embodiments of the present disclosure;

FIG. 3 illustrates a flow chart of an exemplary display method according to various embodiments of the present disclosure;

FIGS. 4a-4d illustrates exemplary implementations of split-screen displays according to various embodiments of the present disclosure;

FIG. 5 illustrates a first detailed flow chart of an exemplary TV display method according to various embodiments of the present disclosure;

FIG. 6 illustrates a second detailed flow chart of an exemplary TV display method according to various embodiments of the present disclosure;

FIG. 7 illustrates a third detailed flow chart of an exemplary TV display method according to various embodiments of the present disclosure;

FIG. 8 illustrates a fourth detailed flow chart of an exemplary TV display method according to various embodiments of the present disclosure; and

FIG. 9 illustrates a structure diagram of an exemplary TV display device according to various embodiments of the present disclosure.

### DETAILED DESCRIPTION

Reference will now be made in detail to exemplary embodiments of the invention, which are illustrated in the accompanying drawings. Hereinafter, embodiments according to the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments according to the present disclosure, all of which are within the scope of the present invention.

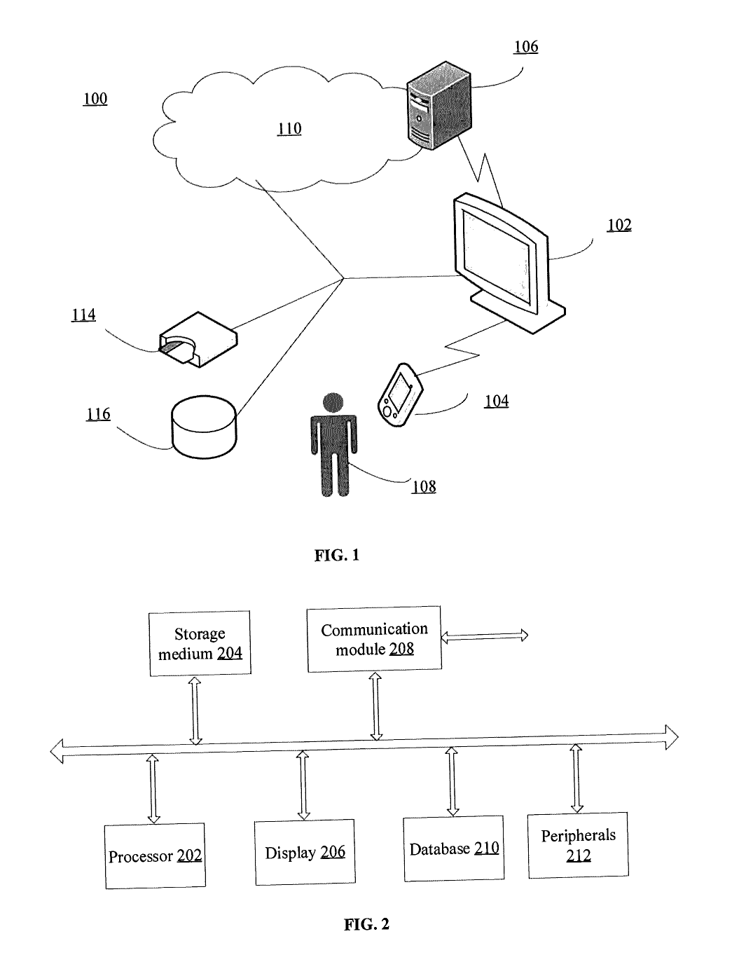

FIG. 1 illustrates an exemplary environment 100 incorporating certain embodiments of the present invention. As shown in FIG. 1, environment 100 may include a television set (TV) 102, a remote control 104, a server 106, a user 108, and a network 110, a portable storage 114, and a data storage 116. Certain devices may be omitted and other devices may be included to provide better descriptions in the present disclosure.

TV 102 may include any appropriate type of TV, such as a plasma TV, a liquid crystal display (LCD) TV, a touch screen TV, a projection TV, a non-smart TV, a smart TV, etc. TV 102 may also include other computing systems, such as a personal computer (PC), a tablet or mobile computer, or a smart phone, etc. Further, TV 102 may be any appropriate content-presentation device capable of presenting multiple programs in one or more channels, which may be controlled through the remote control 104.

The remote control 104 may include any appropriate type of remote control that communicates with and controls the TV 102, such as a customized TV remote control, a universal remote control, a tablet computer, a smart phone, or any other computing device capable of performing remote control functions. The remote control 104 may also include other types of devices, such as a motion-sensor based remote control, or a depth-camera enhanced remote control, as well as simple input/output devices such as a keyboard, a mouse, and a voice-activated input device, etc.

The user 108 may interact with TV 102 using remote control 104 to watch various programs and perform other activities of interest. The user may simply use hand or body gestures to control TV 102 if motion sensor or depth-camera is used by TV 102. If TV 102 is a touch screen TV, the user 108 may also interact with TV 102 by hand gestures. The user 108 may be a single user or a plurality of users, such as family members watching TV programs together.

Further, the server 106 may include any appropriate type of server computer or a plurality of server computers for providing video contents to the user 108. The server 106 may also facilitate communication, data storage, and data processing between the remote control 104 and TV 102. TV 102, remote control 104, and server 106 may communicate with each other through one or more communication networks 110, such as a cable network, a phone network, and/or a satellite network, etc.

The network 110 may include any number of communication networks and servers for providing various contents to the server 106, such as search engines, news websites, shopping websites, video streaming services, etc.

Portable storage 114 may include any appropriate portable storage device for storing contents for TV 102, such as a memory card, a flash disk, and other type of removable storage media. Further, the data storage 116 may be an internal or external data storage device, such as a disk or a database for storing contents for TV 102. The stored contents may include images, videos, encyclopedia, and other appropriate contents. The stored contents may further include personalized information about the user, such as preference settings, favorite programs, user profile, etc.

TV 102, remote control 104, and/or server 106 may be implemented on any appropriate computing circuitry platform. In operation, the computing circuitry platform may identify, search and obtain information from the portable storage 114, the data storage 116, and/or the network 110, and may display the obtained information. FIG. 2 shows a block diagram of an exemplary computing system 200 capable of implementing TV 102, remote control 104, and/or server 106.

As shown in FIG. 2, computing system 200 may include a processor 202, a storage medium 204, a display 206, a communication module 208, a database 210 and peripherals 212. Certain devices may be omitted and other devices may be included.

Processor 202 may include any appropriate processor or processors. Further, processor 202 can include multiple cores for multi-thread or parallel processing. Processor 202 may execute sequences of computer program instructions to perform various processes. Storage medium 204 may include memory modules, such as ROM, RAM, flash memory modules, and mass storages, such as CD-ROM and hard disk, etc. Storage medium 204 may store computer programs for implementing various processes when the computer programs are executed by processor 202, such as computer programs for implementing a face recognition process.

Further, communication module 208 may include certain network interface devices for establishing connections through communication networks. Database 210 may include one or more databases for storing certain data and for performing certain operations on the stored data, such as database searching.

Display 206 may provide information to a user or users of TV 102. Display 206 may include any appropriate type of computer display device or electronic device display such as CRT or LCD based devices. Peripherals 212 may include various sensors and other I/O devices, such as keyboard and mouse.

In operation, the computing system 200, more particularly, processor 202 may perform certain processes to identify a subject of interest and search information related to the subject of interest to provide further processing and applications. For example, the computing system 200 may perform object recognition on the images in the video stream, search related information about the recognized object and send the search results to display 206 for presentation.

That is, in operation, TV 102 may receive a video stream for further processing. The video stream may be from a TV program content provider, locally stored video data, video data received from other sources over the network 110, or video data inputted from other peripherals 212, etc.

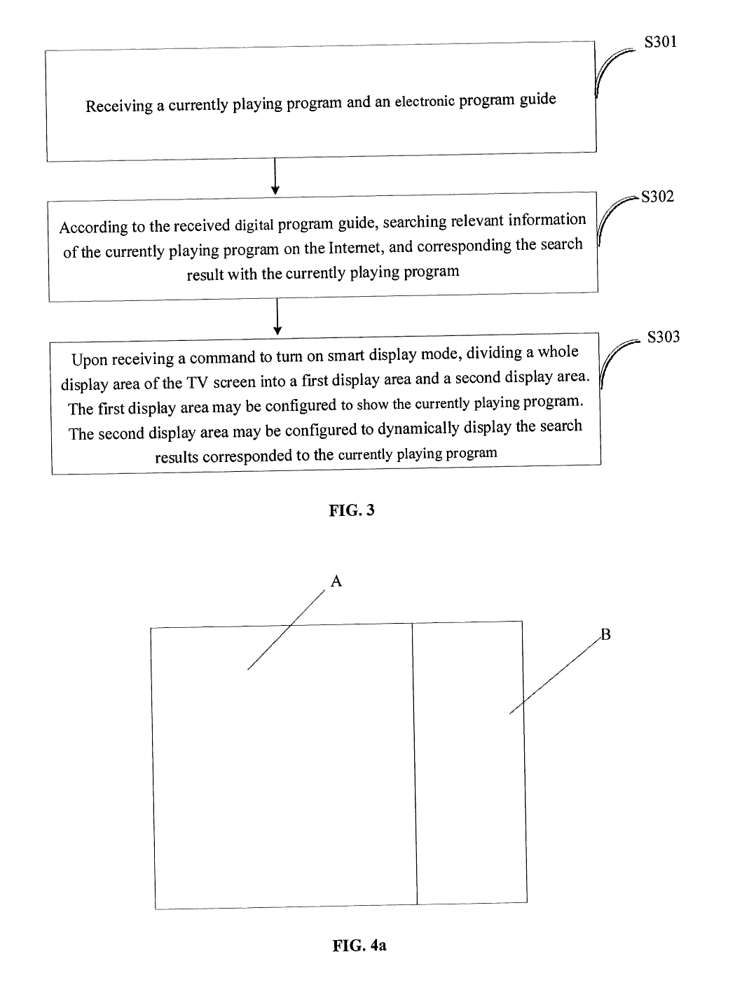

The present disclosure provides a display method. As shown in FIG. 3, an exemplary display method may include the following steps.

A television (e.g. TV 102) may receive information of a currently played program and electronic program guide (S301). In one embodiment, the TV may receive and display programs broadcasted from various TV channels, such as CBS, NBC, HBO, etc. In another embodiment, the TV may receive and display programs from online video content providers and online live stream providers, such as Netflix, YouTube, Twitch, etc. In another embodiment, the TV may receive and display programs from internal data storage or cloud storage. Further, the electronic program guide may include introductory information of the currently played program, such as name, plot, main actors, etc.

According to the received electronic program guide, the TV may search for relevant information of the currently played program, and associate the searched information with the currently played program (S302). The TV may search for relevant information on the internet. Alternatively, the TV may search for relevant information in a local storage or cloud storage.

Upon receiving a command to turn on a smart display mode, the TV may divide the whole display area of its screen into a first display area and a second display area. The first display area may be configured to show the currently played program. The second display area may be configured to dynamically display the searched information corresponded to the currently played program (S303). In one embodiment, the TV may search for relevant information of the currently played program before receiving the command to turn on the smart display mode. In another embodiment, the TV may search for relevant information of the currently played program after receiving the command to turn on the smart display mode.

In the disclosed embodiments, the currently played program and its relevant information from the internet may be displayed on a same screen using a split-screen display, which facilitates users to watch the TV program and to inquire and understand relevant information pulled from the internet at the same time. The user experience is thus enhanced.

In an exemplary embodiment, the TV may be configured to include two display modes: a smart display mode and a normal display mode. When receiving a command to turn on the smart display mode, the TV may be configured to apply a split-screen display. When receiving a command to turn on the normal display mode, the TV may be configured to show the currently played program in full screen. The two display modes may be switched according to users' requirements, therefore satisfying different displaying needs of the users.

In the present disclosure, when receiving a command to turn on the smart display mode, the whole display area of the TV may be divided into a first display area and a second display area, thus a split-screen display may be implemented.

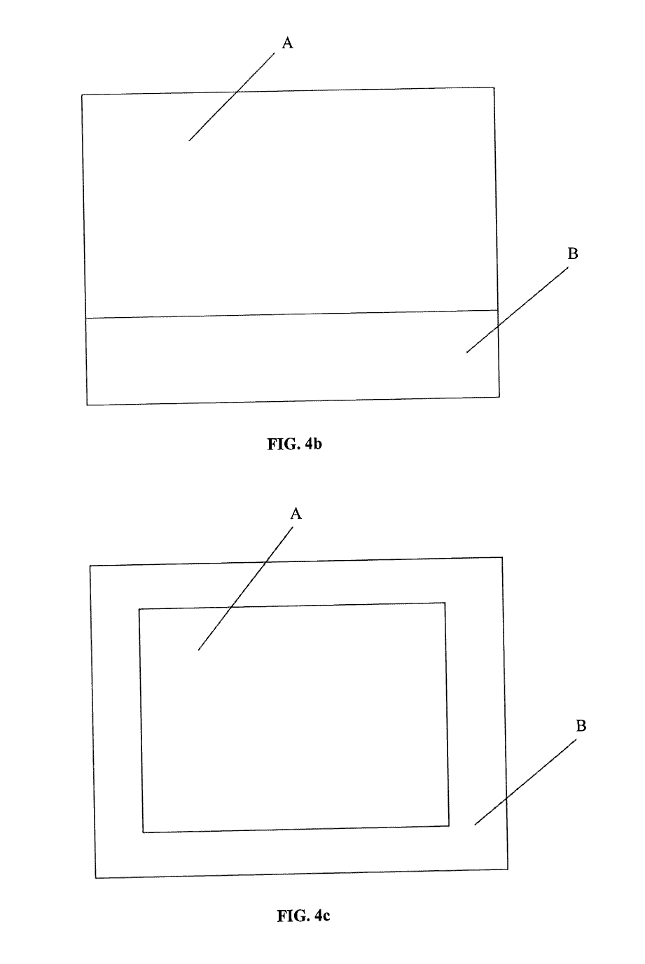

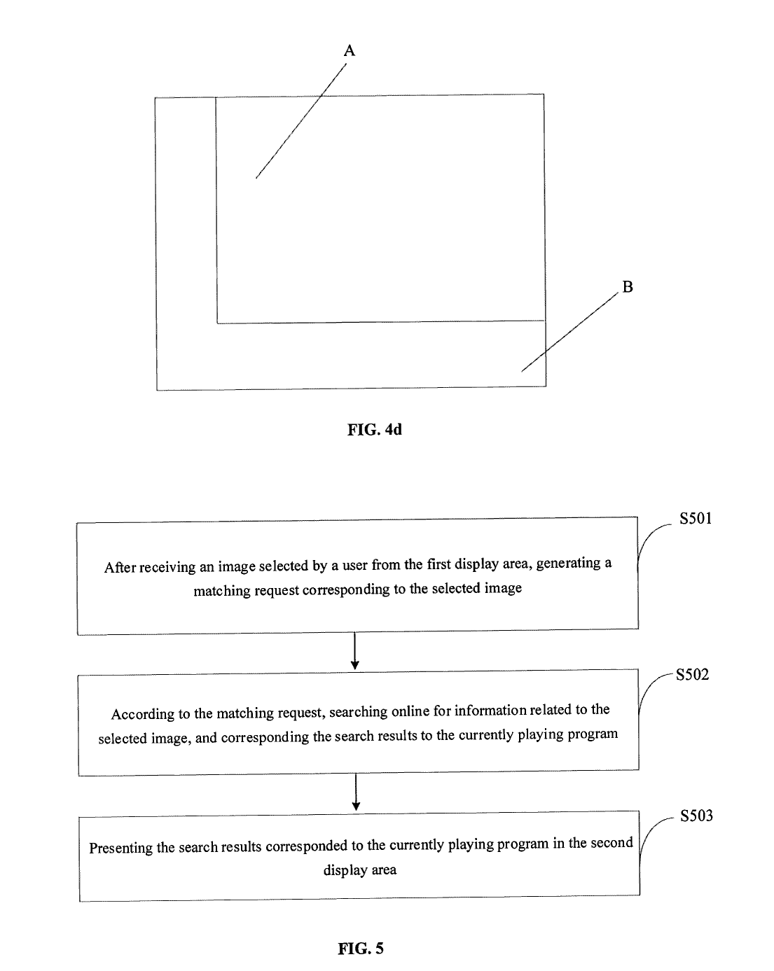

For example, as shown in FIG. 4a, the whole display area may be divided by a vertical division line so that the left side is the first display area A and the right side is the second display area B. In another example, as shown in FIG. 4b, the whole display area may be divided by a horizontal division line so that the upper side is the first display area A and the lower side is the second display area B. In another example, as shown in FIG. 4c, the whole display area may be divided so that the center part is the first display area A and the surrounding part is the second display area B.

In another example, as shown in FIG. 4d, the whole display area may be divided in a way such that the upper right corner part is the first display area A and the remaining part is the second display area B. In other examples, the first display area A may be located in the lower left corner, upper left corner or lower right corner of the whole display area. Correspondingly, the second display area B may be the remaining part of the whole display area. Therefore, any appropriate method may be used to implement the split-screen display. The TV may provide users with multiple options of how to split the screen.

In one embodiment, the whole display area may be divided into the first display area and the second display area according to preset fixed ratios. That is, a first ratio between the first display area and the whole display may be fixed, and a second ratio between the second display area and the whole display area may be fixed. Further, the first ratio may be greater than the second ratio. Thus, the first display area for showing the currently played program is larger than the second display area for showing the relevant information from the internet.

In another embodiment, when the whole display area is divided into the first display area and the second display area, the first display area may be scaled according to the aspect ratio of the currently played program. The aspect ratio may be an original aspect ratio of the currently played program. Alternatively, the aspect ratio may be a preset aspect ratio according to a user's preferences. That is, display size of the currently played program may be adjusted to satisfy users' requirements. The adjusted program and the relevant information from the internet may be respectively displayed on the first display area and the second display area. The sizes of the first display area and the second display area are not fixed and may be adjusted proportionally according to the aspect ratio of the currently played program.

For example, the currently played program may be aired with a certain aspect ratio, such as square format (4:3) or wide screen format (16:9). When splitting the whole display area of the screen, the TV may proportionally resize the first display area according to the aspect ratio such that the currently played program may be played in the same aspect ratio. In another example, the user may customize the aspect ratio of the currently played program. The TV may provide a menu to allow the user to choose from different settings. The first display area may be adjusted according to the settings selected by the user. The screen may be split in a pattern as shown in FIGS. 4a-4d or any other appropriate patterns.

Further, if the TV is a touch screen TV, the user may be able to adjust the sizes and locations of the first display area and the second display area by touches or preset hand gestures. For example, the user may long press the first display area so that the TV may enter a split-screen adjusting mode. The user may drag the first display area to any desired location, and pinch or zoom the first display area to any desired size. The second display area may be relocated or resized corresponding to the changes of the first display area.

In the split-screen display, the picture size of the currently played program may be adjusted to match the size of the first display area. In this way, when switching to the split-screen display, changing the size of the first display area may not affect picture quality of the currently played program.

As shown in FIG. 5, an exemplary display method of the present disclosure may further include the following steps.

After receiving an image selected by a user from the first display area, a matching request containing to the selected image is generated (S501). In one embodiment, when the TV is a touch screen TV, the user may select the image by hand gestures. For example, when the user is interested in a target object in the currently played program, such as a product, a person or a piece of news, the user may tap the screen or a preset icon to enter an object selection mode. In the object selection mode, the user may drag a bounding box to a desired size at a desired location to contain the image of the target object. Further, the user may drag the selected image to the second display area to trigger the matching request. In another embodiment, the user may use a remote control to enter the object selection mode and select an image of the target object in the first display area.

In certain embodiments, when entering the object selection mode, the TV may pause playing the current program and display a frame of the program in the first display area which is the frame displayed when the user requests to enter the object selection mode. After the user has finished selection, the TV may return to play the current program.

According to the matching request, the TV may search online for information related to the selected image, and associate the search results with the currently played program (S502). In an exemplary embodiment, the TV may first extract context information from the selected image, and use the context information as key words to search for relevant information online. The selected image may contain different types of subjects, such as a product, a character, a piece of news. Correspondingly, the context information may be name and brand of a product, name of a character, keywords for news, etc. In some embodiments, users may choose the types of the subject in the selected image. In other embodiments, the TV may automatically decide the types of the subject when extracting the context information.

According to different types of subjects in the selected image, the TV may be configured to use the context information as keywords to search for relevant information with corresponding preset search strategies and ranking strategies. For example, when the selected image is a product, shopping websites and product review websites may be searched with high priorities. When the selected image is a character, results from encyclopedia websites may be returned with high priorities. When the selected image contains news information, major news websites may be searched first.

Further, users may preset their favorite search engines and websites. For example, the user may set amazon.com as the default shopping website, set nytimes.com as the default news website, or set wikipedia.com as the default website for other types of searches. Therefore, the searched information may include results from preset websites as highly ranked search results.

In one embodiment, the TV may use the selected image to search online for context information. For example, the selected image may be a picture of a product. An image search engine may be employed to extract information from the selected image, such as product brand and product model. In another example, the selected image may be a picture of a person, an animal or a plant. The image search engine may be employed to extract the name of the subject. Specifically, the image search engine may return a plurality of web pages. Texts from the highest ranking pages, such as first 10 pages, in the image search results may be analyzed. Most common nouns from the pages, or texts after certain preset words may be considered as context information. The preset words may include brands, names, product types, product models, etc.

In another embodiment, the TV may perform image recognition techniques to preprocess the selected image and extract the context information. For example, when the selected image includes texts, the TV may employ optical character recognition (OCR) algorithms to extract context information.

Further, the electronic program guide may be used to facilitate the search. For example, the current playing program may be an episode of a TV series. The selected image may be a person in the episode. The TV may use image search engine or face recognition techniques to recognize the actor. The name of the TV series may be provided by the electronic program guide. Combining the actor and the name of the TV series, the name of the character that the actor is playing may be recognized and considered as context information. In another example, the electronic program guide may indicate that the current playing program is news. The TV may categorize the subject as news and search for relevant information on news websites.

The display screen may be configured to present the search results corresponded to the currently played program in the second display area (S503). In certain embodiments, the second display area may present the context information extracted from the selected image and list a preset number of items from the search results. Users may scroll down to load more search results in the second display area. External links to related web pages may be presented to allow users to explore on the topic.

For example, when the subject of the selected image is a person, the second display area may present the name of the person and introductory information about this person. In another example, when the subject of the selected image is a piece of news, the second display area may present titles or front pages of the same news topic from three different news sources. In another example, when the subject of the selected image is a product, the second display area may present product name, product specifications, a list of places selling the product and their corresponding prices. The list of places may include a plurality of online shopping websites. The shopping websites may be sorted according to user preferences, such as prices and review scores. Alternatively, the list of places may include a plurality of retail stores. The retail stores may be sorted according to their distance from the user. The operating hours of the retail stores may also be presented.

In various embodiments, when the TV is switched to the smart display mode, a user may select an image in the first display area. Related information of the selected image may be searched online. The search results may be corresponded to the currently played program and presented in the second display area. For example, a user may be interested in a bottle of wine in a scene of a currently played program in the first display area. The user may select the image of the bottle of wine, drag the image to the second display area. The TV may conduct a search of the wine, such as its origin, year and other relevant information. The search results may be displayed in the second display area to help the user to get better understanding of the target object, and thus enhancing the user experience.

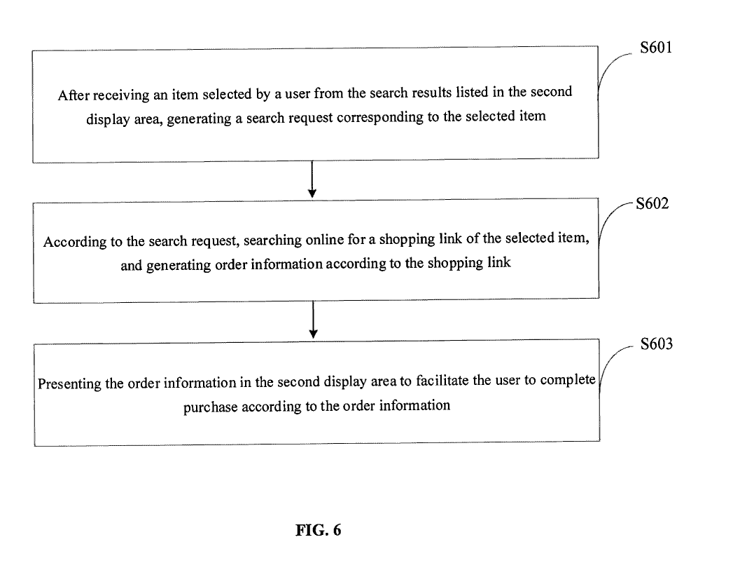

In an exemplary embodiment, as shown in FIG. 6, the disclosed display method may further include the following steps.

After receiving an item selected by a user from the search results listed in the second display area, a search request is generated corresponding to the selected item (S601). For example, when the search results includes a plurality of shopping websites related to a product, a purchase icon may be provided for each shopping website. For example, the icon may be “buy” or “add to cart.” The user may select the icon to initiate the search request.

According to the search request, the TV may search online for a shopping link of the selected item, and generate order information according to the shopping link (S602). The display screen may be configured to present the order information in the second display area to facilitate the user to complete purchase according to the order information (S603). That is, in the second display area, the user may be directed to the shopping website to proceed with the purchase. In certain embodiments, a user may pre-store user profiles in the TV. The user profile may include shipping address, billing address, credit card information, etc. Thus, the user may select to use the pre-stored profile to auto fill the order information. Further, to protect the user's personal information, the user may need to provide certain credentials to access the pre-stored profile, such as a password or a fingerprint.

In various embodiments, when the TV is switched to the smart display mode, to meet users' shopping needs, a user may select an item among the search results presented in the second display area. Related purchase information of the selected item may be searched online. Corresponding purchase information may be generated and displayed in the second display area. The user may place an order based on the purchase information and complete the order. For example, a user may select to buy a bottle of wine from one website among the search results listed in the second display area. The TV may search and display purchase information of the wine in the second display area. The user may perform corresponding operations to order the wine online in the second display area. The disclosed method may facilitate users to buy related products when they are watching TV, and thus enhancing user experiences.

The disclosed display method may be implemented in the two following embodiments.

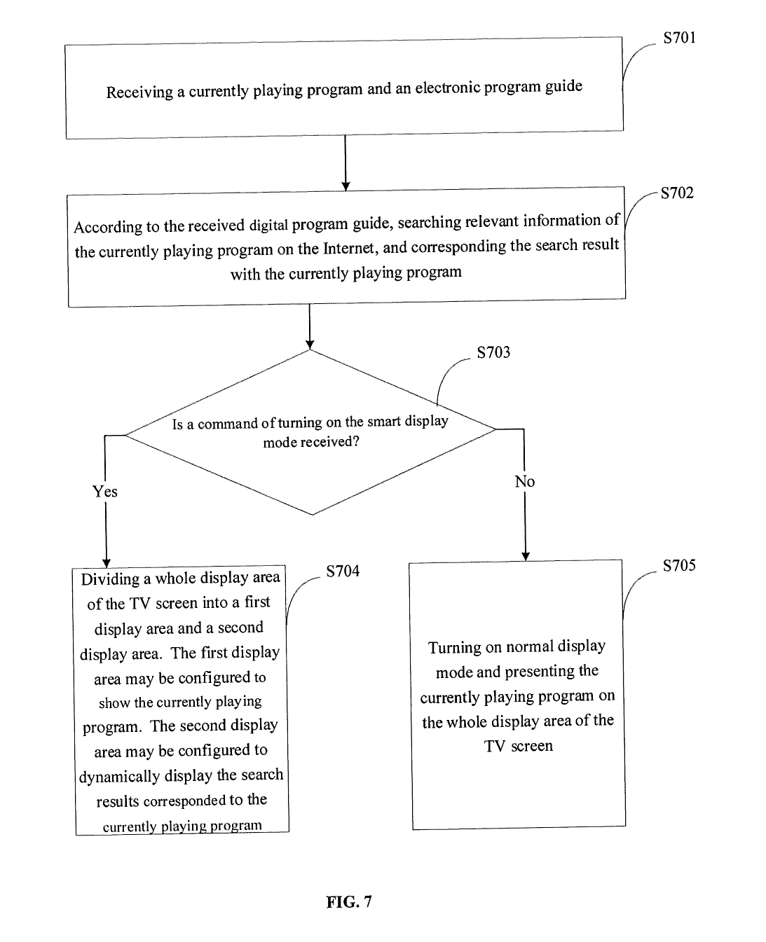

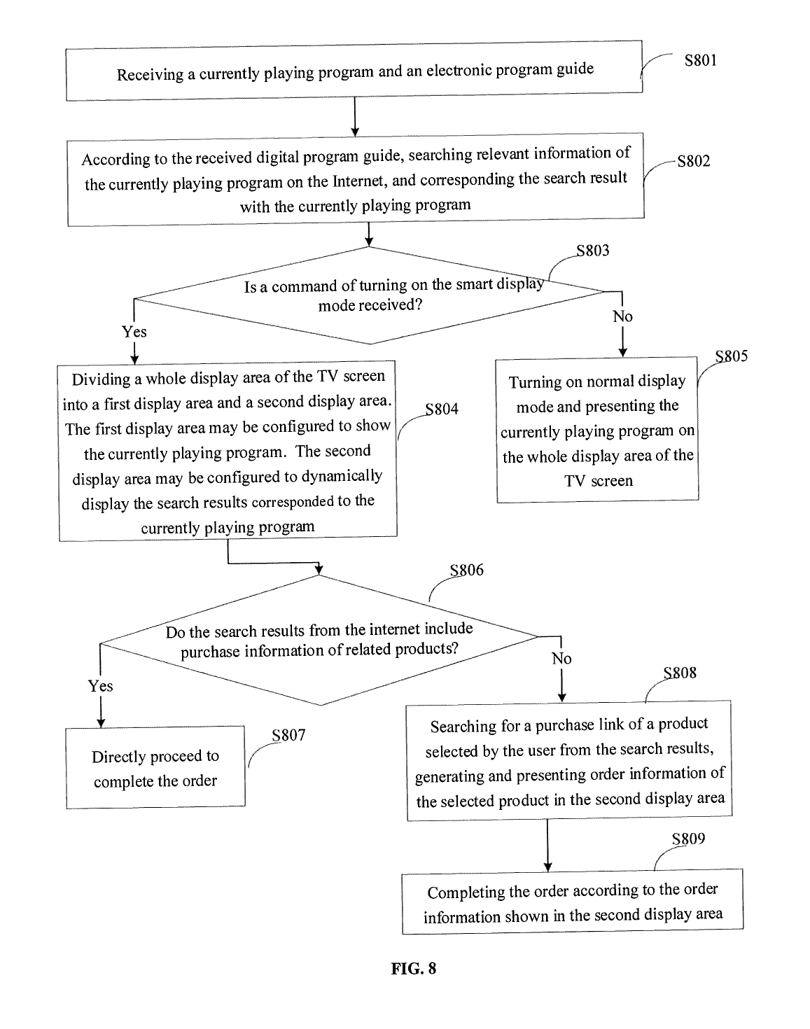

In a first embodiment, as shown in FIG. 7, an exemplary display method of the present disclosure may include the following steps.

A television may receive information of a currently played program and electronic program guide (S701). According to the received electronic program guide, the TV may search for relevant information of the currently played program on the Internet, and associate the search results with the currently played program (S702). The TV may determine whether a command of turning on the smart display mode is received (S703). When the command is received, step S704 is executed. When the command is not received, step S705 is executed.

In step S704, the TV may divide its whole display area into a first display area and a second display area. The first display area may be configured to show the currently played program. The second display area may be configured to dynamically display the search results corresponded to the currently playing TV program.

In step S705, The TV may turn on normal display mode and display the currently played program on the whole display area of the TV screen. That is, the currently played program may be displayed in full screen.

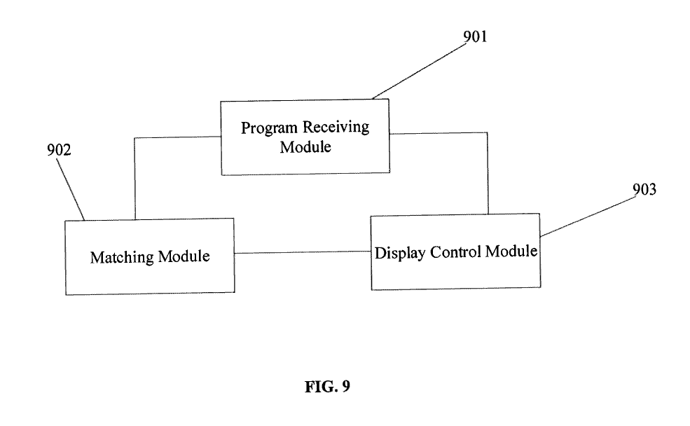

In a second embodiment, as shown in FIG. 8, an exemplary display method may include the following steps.

A television may receive information of a currently played program and an electronic program guide (S801). According to the received electronic program guide, the TV may search for relevant information of the currently played program on the Internet, and associate the search result with the currently played program (S802). The TV may determine whether a command of turning on the smart display mode is received (S803). When the command is received, step S804 is executed. When the command is not received, step S805 is executed.

In step S805, the TV may turn on normal display mode and display the currently played program on the whole display area of the TV screen. In step S804, the TV may divide its whole display area into a first display area and a second display area. The first display area may be configured to show the currently played program. The second display area may be configured to dynamically display the search results corresponded to the currently played program.

In step S806, in the smart display mode, the TV may determine whether the search results from the internet includes purchase information of related products. When there is purchase information of related products, step S807 is performed. When no purchase information is included, step S808 may be performed.

In step S807, the TV may provide an entrance for the user to directly place an order of the product. In step S808, the user may select a related product among the search results. The TV may search for a purchase link of the product, generate order information and show the order information in the second display area. Further, the user may complete the order according to the order information shown in the second display area (S809).

The present disclosure also provides a display apparatus. As shown in FIG. 9, an exemplary display apparatus may include a program receiving module 901, a matching module 902 and a display control module 903. The display apparatus may have a display screen.

The program receiving module 901 may be configured to receive a currently played program and an electronic program guide, send the received program to the display control module 903, and send the received electronic program guide to the matching module 902.

The matching module 902 may be configured to search for relevant information of the currently played program on the Internet according to the received electronic program guide, associate the search result with the currently played program, and send the search results to the display control module 903.

Upon receiving a command to turn on smart display mode, the display control module 903 may be configured to divide a whole display area of the screen into a first display area and a second display area. The display control module 903 may control the screen to show the currently played program in the first display area, and control the screen to dynamically display the search results corresponded to the currently played program obtained from the matching module 902 in the second display area.

In an exemplary embodiment, the disclosed display device may have two display modes: a smart display mode and a normal display mode. When receiving a command to turn on the smart display mode, the display control module 903 may be configured to apply split-screen display. When receiving a command to turn on the normal display mode, the display control module 903 may be configured to show the current program in full screen. The two display modes may be switched according to users' requirements, therefore satisfying different displaying needs of the users.

In one embodiment, the display control module 903 may receive the command to turn on the smart display mode before the matching module 902 searches for relevant information of the currently played program. In another embodiment, the display control module 903 may receive the command to turn on the smart display mode after the matching module 902 searches for relevant information of the currently played program.

In the present disclosure, when receiving a command to turn on the smart display mode, the display control module 903 may be configured to divide the whole display area of the screen into a first display area and a second display area. The screen may be split in different ways.

For example, the display control module 903 may divide the whole display area into the first display area and the second display area according to preset fixed ratios. That is, a first ratio between the first display area and the whole display is fixed, and a second ratio between the second display area and the whole display area is fixed. Further, the first ratio may be greater than the second ratio. Thus, the first display area for showing the currently played program may be larger than the second display area for showing the relevant information of the program from the internet. The screen may be split in examples shown in FIGS. 4a-4d.

In another example, when dividing the whole display area into the first display area and the second display area, the display control module 903 may scale the first display area according to the aspect ratio of the currently played program. The aspect ratio may be an original aspect ratio of the currently played program. Alternatively, the aspect ratio may be a preset aspect ratio according to a user's preferences. That is, the display size of the currently played program may be adjusted to satisfy users' requirements. The adjusted program and the relevant information from the internet may be respectively displayed on the first display area and the second display area. The sizes of the first display area and the second display area are not fixed and may be adjusted proportionally according to the aspect ratio of the currently played program. The screen may be split in any appropriate method and is not limited herein.

In the split-screen display, the display control module 903 may adjust the picture size of the currently played program to match the size of the first display area. In this way, when switching to split-screen display, changing the size of the first display area may not affect picture quality of the currently played program.

In certain embodiments, the display control module may be further configured to receive an image selected by a user from the first display area, send a matching request containing the selected image to the matching module 902, and present search results from the matching module 902 in the second display area. The matching module 902 may be further configured to search online for information related to the selected image based on the matching request, associate the search results with the currently played program, and send the search results corresponding to the currently played program to the display control module 903. Therefore, while enjoying a TV program, a user may request searches of desired contents related to the TV program online. The program and the search results may both be presented on the same screen using split-screen display, and thus enhancing the user experience.

Further, in some embodiments, the display control module may be further configured to receive an item selected by a user from the search results listed in the second display area, send a search request containing the selected item to the matching module 902, and present order information in the second display area to facilitate the user to complete the order according to the order information. The matching module 902 may be further configured to: according to the search request, search online for a shopping link of the selected item, generate order information according to the shopping link, and send the order information to the display control module 903. The disclosed method may facilitate users to search and buy related products when they are watching TV, and thus enhancing user experiences.

The disclosed display method may be applied in TV display devices and other display devices. The disclosed display method and apparatus may be integrated in display panels of various display devices, or configured to be a plug-in device that matches with other display devices. In certain embodiments, the display screen of the display apparatus may be a touchscreen display, which facilitates users to select and drag contents they are interested in. In other embodiments, the display screen may also be other types of screen. Users may use remote controls to select and drag contents that they are interested in.

The present disclosure provides a display method and a display apparatus. A program receiving module may receive a currently played program and an electronic program guide. The program receiving module may send the currently played program to a display control module, and send the electronic program guide to the matching module. The matching module may search for information related to the currently played program, associate the search results with the currently played program, and send the search results to the display control module 903. Upon receiving a command to turn on a smart display mode, the display control module 903 may be configured to divide a whole display area of the screen into a first display area and a second display area, control the screen to show the currently played program in the first display area, and control the screen to dynamically display the search results relating to the currently played program obtained from the matching module 902 in the second display area. Therefore, using the disclosed display method and display apparatus, users may simultaneously watch TV program and search and understand online information related to the TV program. User experience is thus enhanced.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

1-19. (canceled)

20. A display apparatus having a display screen, comprising:
a display control module configured to control a presentation of a currently played TV program;
a program receiving module configured to receive the currently played TV program, and send the currently played TV program to the display control module; and
a matching module configured to search for information related to the currently played TV program, associate the searched information with the currently played TV program, and send the searched information to the display control module;
wherein the display control module is further configured to divide the display screen into a first display area and a second display area, to control the display screen to show the currently played TV program in the first display area, and to control the display screen to dynamically present the searched information associated with the currently played TV program in the second display area.

21. The apparatus according to claim 20, wherein the display control module is further configured to:
control the display screen to divide the display screen into the first display area and the second display area when the display control module receives a command to turn on a smart display mode; and
control the display screen to show the currently played TV program in the whole display area when the display control module receives a command to turn on a normal display mode.

22. The apparatus according to claim 20, wherein the display control module is further configured to:
divide the whole display area into the first display area and the second display area based on fixed ratios, wherein the first display area is larger than the second display area; or
divide the whole display area into the first display area and the second display area based on an aspect ratio of the currently played TV program, wherein an aspect ratio of the first display area equals the aspect ratio of the currently played TV program.

23. The apparatus according to claim 22, wherein the display control module is further configured to:
adjust a picture size of the currently played TV program according to a size of the first display area; and
display the adjusted currently played TV program in the first display area.

24. The apparatus according to claim 20, wherein:
the program receiving module is further configured to receive an electronic program guide together with the currently played TV program, and send the electronic program guide to the matching module; and
the matching module is further configured to search for information related to the currently played TV program according to the received electronic program guide.

25. The apparatus according to claim 20, wherein:
the display control module is further configured to receive an image selected by a user from the first display area, and send a matching request containing the selected image to the matching module;
the matching module is further configured to search online for results related to the selected image based on the matching request, associate the search results with the currently played TV program, and send the search results to the display control module; and
the display control module is further configured to present the search results corresponded to the currently played TV program in the second display area.

26. The apparatus according to claim 20, wherein:
the display control module is further configured to receive an item selected by a user among the searched information presented in the second display area and send a search request containing the selected item to the matching module;
the matching module is further configured to search online for a shopping link of the selected item based on the search request, generate order information according to the shopping link, and send the order information to the display control module; and
the display control module is further configured to present the order information in the second display area to facilitate the user to complete the order according to the order information.

27. The apparatus according to claim 20, wherein:
the display screen is a touch screen.

28. The apparatus according to claim 25, wherein:
the display screen is a touch screen;
when the user touches the display screen to select an image in the first display area, and drag the selected image to the second display area, the display control module is further configured to generate the matching request containing the selected image.

29. A smart display panel incorporating one or more display apparatus according to claim 20.

30. A display method for a display apparatus, comprising:
receiving a currently played TV program;
searching information related to the currently played TV program;
associating the searched information with the currently played TV program;
dividing a whole display area of the display screen into a first display area and a second display area;
displaying the currently played TV program in the first display area; and
displaying the searched information in the second display area.

31. The method according to claim 30, further comprising:
when the display apparatus receives a command to turn on a smart display mode, dividing the whole display area of the display screen into the first display area and the second display area; and
when the display apparatus receives a command to turn on a normal display mode, displaying the currently played TV program in the whole display area of the display screen.

32. The method according to claim 30, wherein dividing the whole display area of the display screen into the first display area and the second display area further comprises one of:
dividing the whole display area into the first display area and the second display area based on fixed ratios, the first display area being larger than the second display area; or
dividing the whole display area into the first display area and the second display area based on an aspect ratio of the currently played TV program so that an aspect ratio of the first display area being equal to the aspect ratio of the currently played TV program.

33. The method according to claim 32, further comprises:
adjusting a picture size of the currently played TV program according to a size of the first display area; and
displaying the adjusted currently played TV program in the first display area.

34. The method according to claim 30, wherein:
receiving the currently played TV program further comprises receiving an electronic program guide corresponding to the currently played TV program; and
searching information related to the currently played TV program further comprises searching information related to the currently played TV program according to the received electronic program guide.

35. The method according to claim 30, further comprising:
generating a matching request containing a selected image when receiving the image selected by a user from the first display area;
searching online for results related to the selected image based on the matching request;
associating the search results with the currently played TV program; and
presenting the search results associated with the currently played TV program in the second display area.

36. The method according to claim 30, further comprising:
receiving an item selected by a user among the searched information presented in the second display area;
generating a search request containing the selected item;
searching online for a shopping link of the selected item;
generating order information according to the shopping link; and
presenting the order information in the second display area to facilitate the user to complete the order according to the order information.

37. The method according to claim 30, wherein:
the display screen is a touch screen.

38. The method according to claim 35, the display screen being a touch screen, the method further comprising:
generating the matching request containing the selected image when the user touches the display screen to select an image in the first display area, and drag the selected image to the second display area.
